(19) United States
(12) Patent Application Publication
(10) Pub. No.: US 2019/0386511 A1
(43) Pub. Date: Dec. 19, 2019

(54) POWER MANAGEMENT SYSTEM, POWER MANAGEMENT DEVICE, AND POWER MANAGEMENT METHOD

(71) Applicant: HITACHI, LTD., Tokyo (JP)

(72) Inventors: Hirofumi TAKAHASHI, Tokyo (JP); Youhei KAWAHARA, Tokyo (JP); Kohei HONKURA, Tokyo (JP); Masatoshi SUGIMASA, Tokyo (JP); Shinsuke ANDOU, Tokyo (JP)

(21) Appl. No.: 16/480,352

(22) PCT Filed: Nov. 28, 2017
(86) PCT No.: PCT/JP2017/042665

§ 371 Date: Jul. 24, 2019

(30) Foreign Application Priority Data
Mar. 24, 2017 (JP) 2017-058420

(51) Int. Cl. H02J 13/00; H02J 3/38; H02J 3/32; G05B 19/042; G06Q 50/06

(52) U.S. Cl. CPC H02J 13/0013; H02J 3/383; G05B 2219/2639; G05B 19/042; G06Q 50/06; H02J 3/32

(57) ABSTRACT

A power management system is provided with: a power supply facility equipped with an electricity storage unit; a user facility using stored power; and an integrated control device for controlling the supply of the stored power on the basis of stored-power use request information from the user facility. The power supply facility specifies the available capacity and time zone of the electricity storage unit to the integrated control device. The user facility specifies, to the integrated control device, a use request amount and a use request time zone when using the stored power. The integrated control device controls the use of the electricity storage unit so as to satisfy the use request amount and the use request time zone specified by the user and the available capacity and time zone specified by the provider.

### TECHNICAL FIELD

The present invention relates to a power management system, a power management device, and a power management method.

### BACKGROUND ART

In recent years, with the spread of devices having electricity storage functions, configurations for efficient use of power have been proposed. That is, as an electricity storage device, a battery such as a lithium ion battery, a lead battery, a NAS battery, and a redox flow battery, a capacitor such as an electric double layer capacitor and a lithium ion capacitor, or a pumping power generation device is connected to a power transmission system, and the respective electricity storage devices are operated according to a purpose of installation.

For example, a battery or capacitor with a capacity and type suitable for each application is installed according to a purpose such as being used as a measure against peak cut of photovoltaic power generation, a measure for stabilizing a frequency in power source load fluctuation, or a backup power at the time of a power failure.

In addition, a power transaction market is being formed, in which an electricity storage device with a relatively large capacity is used to accumulate power at night or the like when an unit price of power is low, and sell the accumulated power to a client at a time zone when the unit price of power is high, such as during the daytime.

Patent Literature 1 discloses a power transaction control system that, upon receiving a transaction request power amount from a client terminal, collates the transaction request power amount with a stored power amount database to identify an electricity storage device that satisfies the transaction request power amount and transmits power acquisition destination candidate information to the client terminal.

### PRIOR ART LITERATURE

### Patent Literature

PTL 1: JP-A-2007-94732

### SUMMARY OF INVENTION

### Technical Problem

As described in Patent Literature 1, it has already been known to control a power transaction using an electricity storage device in the related art, but a power transaction system proposed in the related art uses an electricity storage device that is installed for the purpose of power transaction. That is, in the power transaction system in the related art, an operator who performs power transaction installs an electricity storage device with a relatively large capacity, and connects the electricity storage device with a large capacity to a power system to perform an operation.

Meanwhile, as described above, with the spread of electricity storage devices, there are a large number of electricity storage devices installed with a main purpose other than power transaction, these electricity storage devices are preferred to be used for an original purpose thereof and are difficult to be used for power transaction. For example, when a situation occurs in which selling generated power to a power system is limited, an electricity storage device used as a measure against peak cut of photovoltaic power generation temporarily stores the generated power. Further, when the limitation of selling of the generated power is removed, the stored power is discharged to allow effective use. However, since a photovoltaic power generation facility is limited to operate in the daytime, a time zone in which the electricity storage device can be used is limited, and it cannot be said that the electricity storage device is effectively utilized.

An object of the invention is to provide a power management system, a power management device, and a power management method by which electricity storage devices installed for various purposes can be effectively utilized.

### Solution to Problem

In order to solve the above problems, for example, configurations described in the claims are adopted.

The present application includes a plurality of means to solve the above problems, and one example of them includes a power management system including a power supply facility equipped with an electricity storage unit; a user facility configured to use power stored in the electricity storage unit; and an integrated control unit configured to control supply of the power stored in the electricity storage unit of the power supply facility on the basis of stored-power use request information from the user facility.

Here, the power supply facility includes a provider side control device configured to specify an available capacity and an available time zone of the electricity storage unit to the integrated control device.

The user facility includes a user side control device configured to specify, to the integrated control device, a use request amount and a use request time zone when the stored power of the electricity storage unit is used.

Further, the integrated control device is configured to control the use of the electricity storage unit so as to satisfy the use request amount and the use request time zone specified by the user side control device and the available capacity and the available time zone specified by the provider side control device.

### Advantageous Effect

According to the invention, when there is a time zone in which an electricity storage unit is not used and there is a surplus in any one of the chargeable power amount, the dischargeable power amount, the input performance or the output performance, it is possible to effectively utilize the time zone in which the electricity storage unit is not used and the surplus. As a result, a total amount of electricity storage units required by the overall power system can be reduced.

Problems, configurations, and effects other than those described above will be clarified by descriptions of the following embodiments.

### BRIEF DESCRIPTION OF DRAWINGS

FIG. 1 is a system configuration diagram showing a configuration example of an overall system according to a first embodiment of the invention.

FIG. 2 is a configuration diagram showing an example of control devices provided in facilities according to the first embodiment of the invention.

FIG. 3 is a block diagram showing a hardware configuration example of each control device according to the first embodiment of the invention.

FIG. 4 is a flowchart showing a flow of control processing performed by an integrated control device according to the first embodiment of the invention.

FIG. 5 is an explanatory diagram showing an example of a control state according to the first embodiment of the invention.

FIG. 6 is an explanatory diagram showing an example of an input screen in a provider side control device according to the first embodiment of the invention.

FIG. 7 is a flowchart showing a control example according to the first embodiment of the invention.

FIG. 8 is a configuration diagram showing an example of control devices provided in facilities according to a second embodiment of the invention.

FIG. 9 is a flowchart showing a control example according to the second embodiment of the invention.

FIG. 10 is a configuration diagram showing an example of control devices provided in facilities according to a third embodiment of the invention.

FIG. 11 is a flowchart showing a control example according to the third embodiment of the invention.

FIG. 12 is an explanatory diagram showing an example of an input screen in a provider side control device according to the third embodiment of the invention.

### DESCRIPTION OF EMBODIMENTS

### 1. First Embodiment

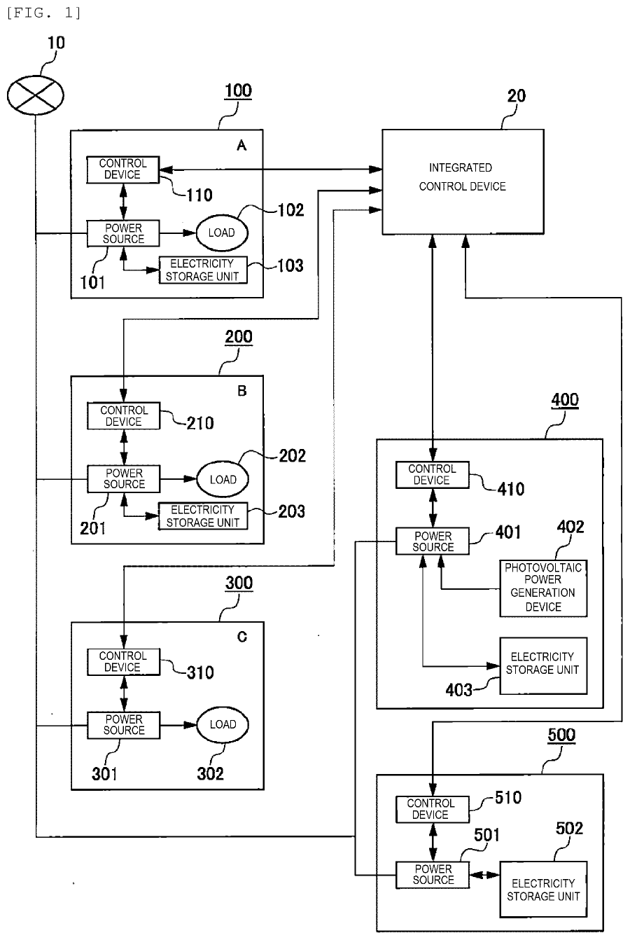

Hereinafter, a first embodiment of the invention will be described with reference to FIGS. 1 to 7.

### [1-1. Configuration of Overall System]

FIG. 1 shows a configuration example of each unit connected to a power system 10 including a power management system according to the first embodiment of the invention.

In the example shown in FIG. 1, a plurality of user side facilities 100, 200, and 300 and a plurality of power supply facilities 400 and 500 are prepared, and each of the facilities 100 to 500 is connected to the power system 10. The power system 10 supplies an AC power source or a DC power source to each of the facilities 100 to 500, and supplies an AC power source or a DC power source obtained from the power supply facilities 400 and 500 to other facilities (for example, the user side facilities 100, 200 and 300). The power system 10 may be either a system based on a power transmission and distribution network operated by a so-called power company (power supply business operator) or a dedicated system prepared by a business operator who operates a power management system according to the present embodiment.

Here, the user side facilities 100, 200, and 300 are individual buildings (A building, B building, and C building), and include load devices 102, 202, and 302 that consume power, respectively. The load devices 102, 202, and 302 include various devices that consume power, such as an air conditioning facility and lighting facility provided in each building. Each of the load devices 102, 202, and 302 receives a supply of power from the power system 10 via power source devices 101, 201, and 301. In the example of FIG. 1, the user side facilities 100 and 200 include electricity storage units 103, and 203, and the electricity storage units 103 and 203 are connected to the power source devices 101 and 201, respectively. The electricity storage units 103 and 203 are installed for the purpose of lowering a power rate used in the user side facilities 100 and 200, for example, by being charged in a time zone in which the power unit price is low and being discharged in a time zone in which the power unit price is high. The user side facility 300 is shown as an example in which the electricity storage unit is not provided therein.

The supply of power from the power system 10 is controlled by user side control devices 110, 210, and 310 in the user side facilities 100, 200, and 300. Further, charging and discharging in the electricity storage units 103 and 203 are also controlled by the user side control devices 110 and 210 of the user side facilities 100 and 200, respectively. The user side control devices 110, 210, 310 communicate with an integrated control device 20 that controls the overall power management system.

The power supply facilities 400 and 500 respectively include electricity storage units 403 and 502 for storing power. The power supply facility 400 also includes a photovoltaic power generation device 402.

The photovoltaic power generation device 402 and the electricity storage unit 403 of the power supply facility 400 are connected to a power source device 401, and the power generated by the photovoltaic power generation device 402 or the power stored in the electricity storage unit 403 is supplied to the power system 10. The power generated by the photovoltaic power generation device 402 is charged to the electricity storage unit 403 as necessary. The electricity storage unit 403 provided in the power supply facility 400 stores power when an amount of power supplied to the power system 10 by the power generated by the photovoltaic power generation device 402 exceeds a capacity of the power system 10. For this reason, in the power supply facility 400, the power generated by the photovoltaic power generation device 402 is efficiently used.

In the power supply facility 500, the electricity storage unit 502 is connected to a power source device 501, and the power supplied from the power system 10 is charged into the electricity storage unit 502, or the power stored in the electricity storage unit 502 is discharged to the power system 10. The electricity storage unit 502 provided in the power supply facility 500 is installed for various purposes, for example, as a measure against peak time of power consumption in the power system 10 or as a measure for stabilizing the power supply frequency of the power system 10.

The power transmission to the power system 10 by the power source devices 401 and 501 and the charging and discharging of the electricity storage units 403 and 502 are controlled by provider side control devices 410 and 510. The provider side control devices 410 and 510 communicate with the integrated control device 20 that controls the overall power management system.

The integrated control device 20 is a device installed on an operator side (such as a power supply company) that operates the power management system according to the present embodiment. The integrated control device 20 communicates with the user side control devices 110, 210, 310 and the provider side control devices 410, 510 of the facilities 100 to 500 and confirms a use status or the like of each of the electricity storage units 103, 203, 403 and 502. Then, charging or discharging is specified to each of the electricity storage units 103, 203, 403 and 502 as necessary. That is, although the respective electricity storage units 103, 203, 403, and 502 are charged and discharged under the control of the control devices 110, 210, 410, and 510 of the respective facilities, the charging or discharging control is also performed according to an instruction from the integrated control device 20.

Various electricity storage devices capable of charging and discharging can be applied to the respective electricity storage units 103, 203, 403, and 502. For example, a battery such as a lithium ion battery, a lead battery, a NAS battery, a redox flow battery, a capacitor such as an electric double layer capacitor and a lithium ion capacitor, or an electricity storage device based on pumping power generation can be applied.

In addition, in the configuration in FIG. 1, although three user side facilities 100, 200, and 300 and two power supply facilities 400 and 500 are connected to the power system 10, the number of the user side facilities and the power supply facilities can be changed according to an actual system configuration. For example, a configuration in which only one user side facility 100 and one power supply facility 400 are connected to the power system 10 may be used. Alternatively, a larger system in which user side facilities and power supply facilities (not shown) are connected to the power system 10 may be used.

### [1-2. Configuration of Control Device]

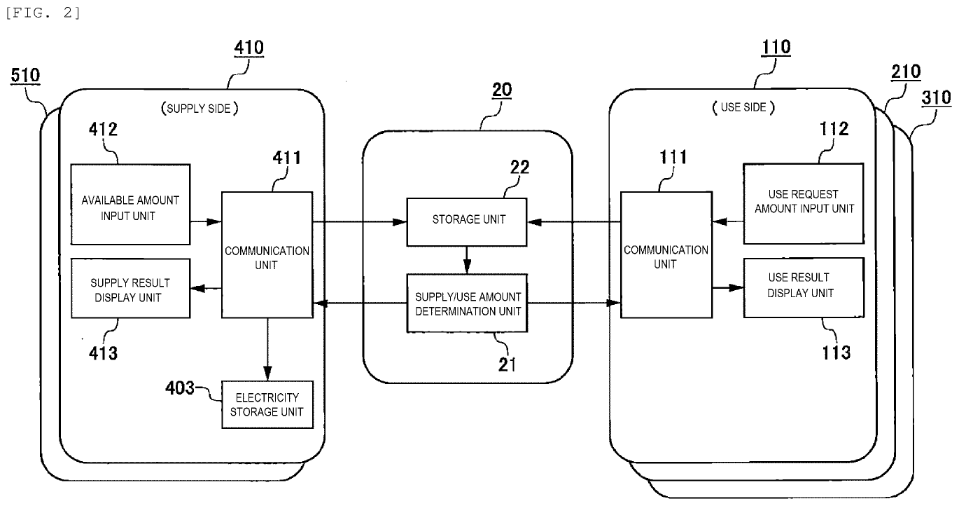

FIG. 2 shows functional blocks of the integrated control device 20, the user side control device 110, and the provider side control device 410. In FIG. 2, configurations of the user side control device 210, 310 and the provider side control device 510 are not shown, and the configurations of the user side control device 210 and 310 are similar to that of the user side control device 110 and the configuration of the provider side control device 510 is similar to that of the provider side control device 410.

The integrated control device 20 includes a supply/use amount determination unit 21 and a storage unit 22. The supply/use amount determination unit 21 controls a use status of each of the electricity storage units 403 and 502 so as to satisfy desired power use amounts from the respective user side control devices 110, 210 and 310 and supply use amounts of the electricity storage units 403 and 502 from the respective provider side control devices 410 and 510.

The storage unit 22 of the integrated control device 20 stores use request amounts of stored-power transmitted from the respective user side control devices 110 and 210 and the supply use amounts of the electricity storage units transmitted from the respective provider side control devices 410 and 510. Here, the use request amount and the supply use amount stored in the storage unit 22 also include information on time zones in which the electricity storage units are used and time zones in which the electricity storage units supply power. When the electricity storage units 103 and 203 provided in the user side facilities 100 and 200 are used, user side control devices 110 and 210 send information on the supply use amounts of the electricity storage units 103 and 202 to the integrated control device 20.

The supply/use amount determination unit 21 adds up all the supply use amounts of the electricity storage units stored in the storage unit 22, and acquires available stored power amounts in respective time zones. Then, within the range of the available stored power amount, use amounts that can be allocated to the respective user side facilities 100, 200 and 300 are determined. The determined allocation of use amounts of the electricity storage units are transmitted to the respective control devices 110, 210, 310, and 510.

The user side control device 110 includes a communication unit 111, a use request amount input unit 112, and a use result display unit 113.

The communication unit 111 communicates with the integrated control device 20. An operator (administrator) of the user side facility 100 inputs a use request amount of the stored power in the load device 102 (FIG. 1) to the use request amount input unit 112.

The use result display unit 113 displays results of using the stored power by the user side facility 100. The use results displayed in the use result display unit 113, for example, a use result of the electricity storage unit 103 of the user side facility 100 and use results of the electricity storage units 203, 403, and 502 of other facilities 200, 400, and 500, are displayed separately. Alternatively, the use result display unit 113 may display only the use results of the electricity storage units 203, 403 and 502 of other facilities 200, 400 and 500.

The provider side control device 410 includes a communication unit 411, an available amount input unit 412, and a supply result display unit 413.

The communication unit 411 communicates with the integrated control device 20.

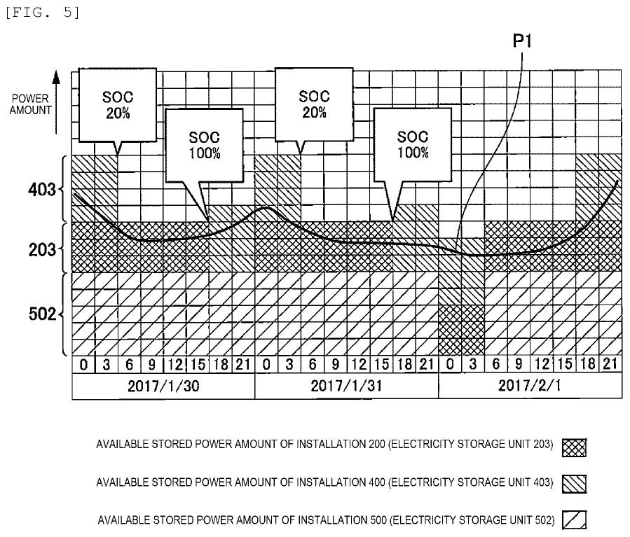

An operator (administrator) of the power supply facility 400 inputs a supply request amount within the power storage capacity of the electricity storage unit 403 to the available amount input unit 412. An example of a specific input screen of inputting the supply request amount of the stored power will be described below (FIG. 5). The supply result display unit 413 displays a result of the stored power supplied by the electricity storage unit 502 of the power supply facility 400.

### [1-3. Hardware Configuration Example of Each Control Device]

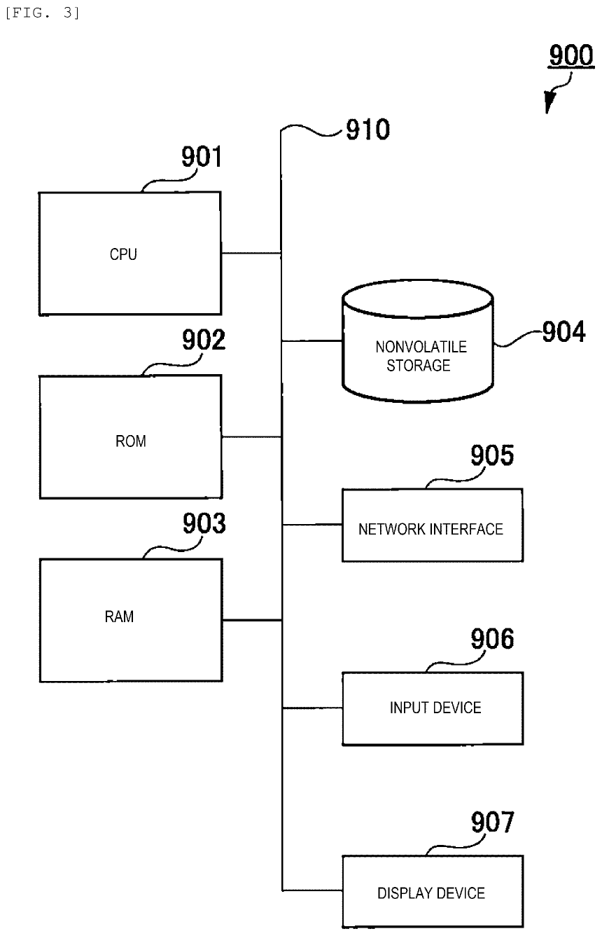

FIG. 3 shows a hardware configuration example of the integrated control device 20, the user side control devices 110, 210, 310 and the provider side control devices 410 and 510. The control devices 20, 110, 210, 310, 410, and 510 are configured by a computer device C.

As shown in FIG. 3, a computer device 900 includes a Central Processing Unit (CPU) 901, a Read Only Memory (ROM) 902, and a Random Access Memory (RAM) 903 that are connected to a bus line 910. Further, the computer device 900 includes a display device 907, an input device 906, a nonvolatile storage 904, and a network interface 905.

The CPU 901 reads out, from the ROM 902, a program code of software that implements functions necessary for controlling each electricity storage unit, and executes the program code. Variables, parameters, or the like generated during arithmetic processing are temporarily written in the RAM 903.

As the nonvolatile storage 904, for example, a Hard Disk Drive (HDD), a Solid State Drive (SSD), a flexible disk, an optical disk, a magneto-optical disk, a CD-ROM, a CD-R, a magnetic tape, a nonvolatile memory, or the like can be used. In addition to an Operating System (OS) and various parameters, a program for causing the computer device C to function as a control device is stored in a nonvolatile storage C7.

For example, a Network Interface Card (NIC) or the like may be employed for the network interface 905, and various types of data can be transmitted and received via a Local Area Network (LAN) or a dedicated line to which terminals are connected. For example, communication between the integrated control device 20 and the other control devices 110, 210, 310, 410, and 510 is performed by transmission and reception through the network interface 905.

The display device 907 and the input device 906 are used for displaying or inputting, for example, a use request amount or a supply amount. For example, the use request amount input unit 112 provided in the user side control device 110 is configured by the input device 906, and the use result display unit 113 provided in the user side control device 110 is configured by the display device 907.

### [1-4. Control Example of Integrated Control Device]

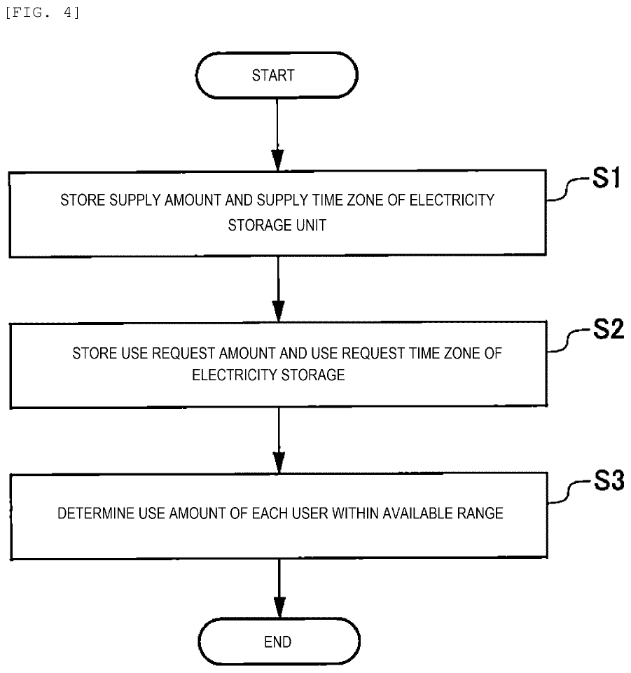

FIG. 4 is a flowchart showing a flow of control processing performed by the integrated control device 20.

First, the integrated control device 20 receives supply requests of the stored power transmitted from the provider side control devices 410 and 510, and stores the supply requests of the stored power in the storage unit 22 (step S1). At this time, the storage unit 22 also stores information on time zones in which the respective power storage units supply the stored power storage. If necessary, the integrated control device also receives supply requests of the stored power transmitted from the user side control devices 110 and 210 of the facilities 100 and 200 including the electricity storage units 103 and 203, and stores the supply requests in the storage unit 22.

Next, the integrated control device 20 receives use request of the stored power from the user side control devices 110 and 210, and stores the use requests of the stored power in the storage unit 22 (step S2). At this time, information on the time zones in which the electricity storage units are used is also stored in the storage unit 22.

Thereafter, the supply/use amount determination unit 21 of the integrated control device 20 adds up all the supply use amounts of the electricity storage units stored in the storage unit 22, and acquires the available stored power amounts in respective time zones. Then, within the range of the available stored power amount, the supply/use amount determination unit determines use amounts that can be allocated to the respective user side facilities 100, 200 and 300 (step S3).

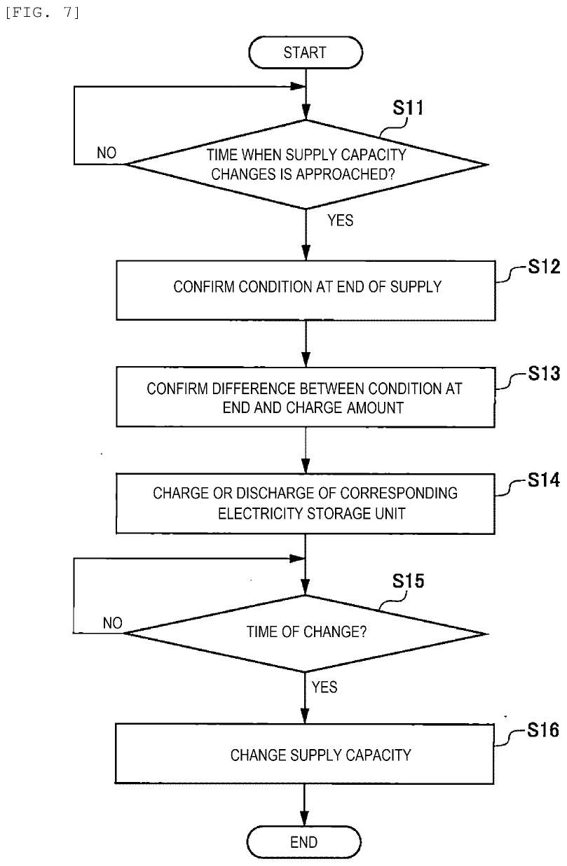

In step S1, when the integrated control device 20 receives the available stored power amount and is to end the supply of the stored power amount, the integrated control device 20 receives information indicating a state of charge at which the ending is performed, and stores the information in the storage unit 22. Then, when the supply of the corresponding amount of stored power is ended, the supply/use amount determination unit 21 performs control to set the specified state of charge. A specific example of processing for controlling the state of charge at the supply end time will be described below (FIG. 7).

FIG. 5 shows an example of a change of control state of the respective electricity storage units over time. In the example of FIG. 5, allocation states during three days of Jan. 30, 31, and Feb. 1, 2017, is shown. In FIG. 5, the horizontal axis indicates time zones each representing three hours, and the vertical axis indicates the power amount.

In FIG. 5, changes every 3 hours of the available stored power amount of the electricity storage unit 203 of the facility 200, the available stored power amount of the electricity storage unit 403 of the facility 400, and the available stored power amount of the electricity storage unit 502 of the facility 500 are indicated by hatched ranges.

The characteristic P1 shown in FIG. 5 indicates a total use amount used by the respective electricity storage units 203, 403, and 502. The use amount P1 is equal to or less than the supply amount set by the electricity storage units 203, 403 and 502 in any time zone.

In the example of FIG. 5, for example, the electricity storage unit 403 of the power supply facility 400 including the photovoltaic power generation device 402 is installed to temporarily store power when an amount of power generation exceeds a power amount that can be transmitted during the daytime in which power generation is performed, and is not charged at night when power generation is not performed. For this reason, an available time zone of the electricity storage unit 403 is set from 18:00 in the evening to 6:00 in the morning.

In the electricity storage unit 403, State of Charge (SOC) is specified to 20% when the available time zone ends. As described above, by ending the available time zone with a state of charge of 20%, the output from the power supply facility 400 can be adjusted by charging or discharging of the electricity storage unit 403 no matter the output of the photovoltaic power generation device 402 increases or decrease when the available time zone ends.

In addition, for the reason of maintenance or the like, an unavailable time zone of the electricity storage unit 502 of the power supply facility 500 is set from 0:00 to 6:00 of February 1, and other time zones are set as available time zones.

Further, the electricity storage unit 203 of user side facility 200 is installed to deal with relatively large power use in the load device 202 of the user side facility 200 for 6 hours from 18:00 in the evening on specific days of the week (30 and 31, January) to 0:00 on the next day. The electricity storage unit 203 is not used in other time zones, and the time zones in which the electricity storage unit 203 is not used are set as available time zones of the electricity storage unit 203. In the days of the week when electricity storage unit 203 is not used at any time, all time zones are set as available time zones of the electricity storage unit 203.

In the electricity storage unit 203, the state of charge (SOC) is specified as 100% when the available time zone ends. In the user side facility 200, by ending the available time zone with a state of charge of 100% for the electricity storage unit 203 of the user side facility 200, the load device 202 can fully use the power stored in the electricity storage unit 203 when the available time zone ends.

In the example of FIG. 5, a state of charge at the end of an available time zone is not particularly set for the electricity storage unit 502, but the state of charge of the electricity storage unit 502 at the end time may be set similar to other electricity storage units 203 and 403.

Then, the supply/use amount determination unit 21 performs control so as to make the use amount P1, which is an actual use amount of the electricity storage units 203, 403, and 502, equal to or less than the total supply amount in any time zone.

As shown in FIG. 5, when plenty of electricity storage units 203, 403, 502 are provided and there are a plurality of facilities (user side facilities 100, 200, 300) to be used, the integrated control device 20 may determine which electricity storage unit can be used by the respective user facilities. For example, it is determined to combine a provider side facility and a user side facility existing close to an installation location of each facility. In this way, the influence on the power system can be reduced when an electricity storage unit of another facility is used.

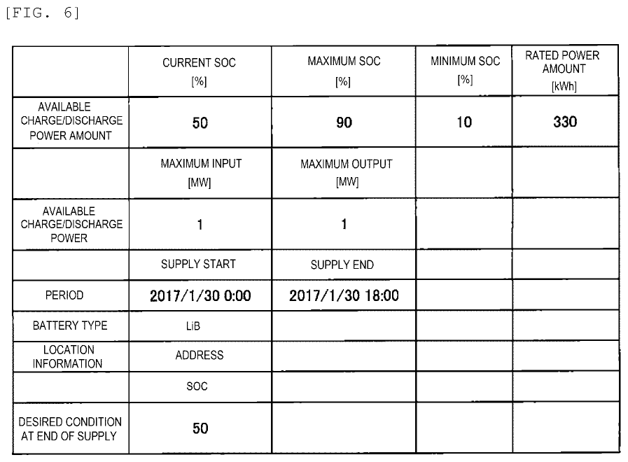

FIG. 6 shows an example of a screen of the control device 410 at the time of inputting the available amount in the available amount input unit 412 of the provider side control device 410.

When the available amount is input, a maximum state of charge (here, SOC 90%), a minimum state of charge (here, SOC 10%), and a rated power amount (here, 330 kWh) of the electricity storage unit 403 are set. A maximum input power (here, 1 MW) at the time of charging and a maximum output power (here, 1 MW) at the time of discharging are set. Also, a supply start time and a supply end time are set. Further, information on a type and an installation location (address) of the storage battery is set. Further, a desired condition (here, SOC 50%) of the state of charge at the end of the supply is set.

The setting shown in FIG. 6 is performed for each of all the electricity storage units 203, 403, and 502 that supply power, and the setting information is stored in the storage unit 22.

FIG. 7 is a flowchart showing processing for changing a state of charge of an electricity storage unit to a specified state of charge on the basis of the control of the integrated control device 20 when the capacity of a provided power storage unit is changed.

First, the supply/use amount determination unit 21 determines whether a time when a capacity of an electricity storage unit being in power supply changes is approached (step S11). Here, when it is determined that the time when the capacity of the electricity storage unit being in power supply changes is not approached (NO in step S11), the supply/use amount determination unit 21 waits until the time when the capacity changes is approached.

If it is determined that the time when the capacity of the electricity storage unit being in power supply changes is approached (YES in step S11), the electricity storage unit 21 reads and confirms a condition of the change time (end time) stored in the storage unit 22 (step S12). Then, the supply/use amount determination unit 21 confirms a difference between the confirmed desired capacity at the end of the supply and a current state of charge of the corresponding electricity storage unit (step S13). Thereafter, the supply/use amount determination unit 21 causes the corresponding electricity storage unit to perform discharge or charge on the basis of the difference confirmed in step S13 (step S14).

Then, the supply/use amount determination unit 21 determines whether the time when the capacity of the electricity storage unit being in power supply changes is reached (step S15), and waits until the change time is reached if the corresponding time is not reached (NO in step S15). If the corresponding time is reached (YES in step S15), the supply/use amount determination unit 21 changes the capacity to be supplied (step S16).

In this way, when the capacity of the electricity storage unit being in power supply is changed, the electricity storage unit in which the supply is ended can be immediately used for an original purpose thereof by charging the electricity storage unit by a predetermined capacity and opening the electricity storage unit. For example, by ending the available time zone with the state of charge of 100%, the power stored in the electricity storage unit can be fully used when the available time zone ends. Alternatively, the electricity storage unit is in a charged state with a certain amount of capacity such as a state of charge of 20% or the like, so that the electricity storage unit can be brought to a charging or discharging state and can be appropriately used for output adjustment.

### 2. Second Embodiment

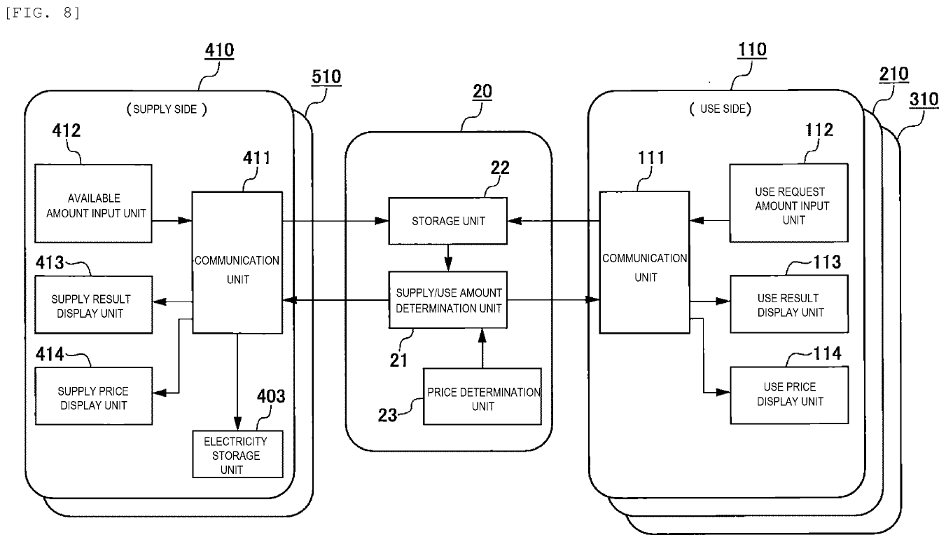

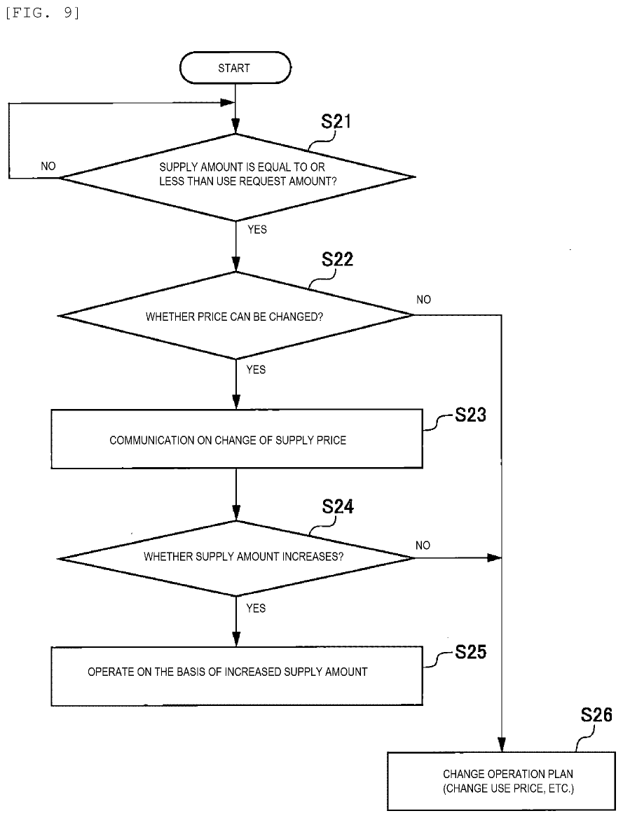

Next, a second embodiment of the invention will be described with reference to FIGS. 8 and 9. In FIG. 8 showing the second embodiment, components same as those in FIG. 2 described in the first embodiment are denoted by the same reference numerals, and a repeated description thereof will be omitted.

In the second embodiment, as shown in FIG. 8, the integrated control device 20 includes a price determination unit 23 in addition to the supply/use amount determination unit 21 and the storage unit 22. The user side control device 110 includes a use price display unit 114, and the provider side control device 410 includes a supply price display unit 414.

Further, the price determination unit 23 of the integrated control device 20 sends, to the provider side control device 410, a price (power unit price) at the time of supply using the electricity storage unit 403. The provider side control device 410 displays the price determined by the price determination unit 23 of the integrated control device 20 at the time of supply using the electricity storage unit 403 on the supply price display unit 414.

Further, the price determination unit 23 of the integrated control device 20 sends, to the user side control device 110, the price (power unit price) when the electricity storage unit 403 of the provider side control device 410 is used. The user side control device 110 displays the price determined by the price determination unit 23 on the use price display unit 114.

Other configurations of the second embodiment are the same as those described in the first embodiment.

As shown in FIG. 8, in the second embodiment, the integrated control device 20 includes the price determination unit 23, and it is possible to set prices according to the respective facilities by determining a supply price and a use price by the price determination unit 23.

For example, since the discharge from the electricity storage unit corresponds to power selling from the supply side to the use side, the price can be determined to an amount corresponding to a transaction price of the power exchange.

It is also possible to set the price to reflect deterioration of electricity storage elements provided in the electricity storage unit caused by the use. A service life of the electricity storage element may be defined by a total charge and discharge times and a usable period. Examples of methods for reflecting the deterioration in respective cases will be described below.

Capacity use cost (yen/kWh)=(capacity unit price (yen/Wh) of electricity storage element)/(total charge and discharge times×usable range)

Output use cost (yen/kW/day)=(capacity unit price (yen/Wh) of electricity storage element)/C rate (1/h))/(usable period (Day))

Here, the usable range is calculated in such that, for example, the usable range is 1 when a lithium ion battery can be used with the charge state thereof from 100% to 0%, and the usable range is 0.8 when the charge state is limited to 90% to 10%. C rate is a reciprocal of the time required to release the total energy. By using either of the capacity use cost or the output use cost alone or the combination of the two costs, it is possible to calculate a decrease in value caused by the deterioration of the electricity storage element. An appropriate price can be set by paying a cost equal to or higher than the cost calculated in this way to the supply side.

In a case where a supply amount of the electricity storage unit specified by each facility on the supply side is smaller than a use request amount, the price determination unit 23 may change the supply price to a high price to increase the supply amount.

FIG. 9 is a flowchart showing an example of processing in this case.

First, the price determination unit 23 determines whether a sum of the supply amounts of the electricity storage units specified by the respective facilities on the supply side is less than a sum of the use request amounts (step S21). Here, if the sum of the supply amounts of the electricity storage units is equal to or larger than the sum of the use request amounts (NO in step S21), the price determination unit 23 stands by without performing price change processing.

Further, if the sum of the supply amounts of the electricity storage units is less than the sum of the use request amounts (YES in step S21), the price determination unit 23 determines whether the supply price can be changed by a contract or the like with each facility side (step S22). Here, if the supply price cannot be changed (NO in step S22), the processing proceeds to step S26, and the supply/use amount determination unit 21 changes an operation plan so as to reduce the use amount. For example, the supply/use amount determination unit 21 performs a countermeasure such as increasing the use price with respect to the price determination unit 23. In the case of increasing the use price, for example, a change in the use price is displayed on the use price display unit 114 of the user side control device 110 in response to communication from the price determination unit 23.

If it is determined in step S22 that the supply price can be changed (YES in step S22), the price determination unit 23 communicates with the respective facilities on the supply side to change the supply price to a high price (step S23). In response to the communication, for example, the changed price is displayed on the supply price display unit 414 of the provider side controller 410.

Thereafter, the supply/use amount determination unit 21 determines whether the supply amount increases (step S24). If the supply amount does not increase (NO in step S24), the processing proceeds to step S26.

If it is determined in step S24 that the supply amount increases (YES in step S24), the supply/use amount determination unit 21 operates the electricity storage unit on the basis of the increased supply amount (step S25).

As described above, since the integrated control device 20 is provided with the price determination unit 23, it is possible to calculate the capacity use cost and the output use cost and set an appropriate supply price and use price. Further, since the user side control device 110 is provided with the use price display unit 114 and the provider side control device 410 is provided with the supply price display unit 414, it is possible to appropriately change a supply capacity or a use capacity according to each of the prices at the supply side and the use side. The price setting may be performed in real time, or may be performed in advance according to previous result data.

### 3. Third Embodiment

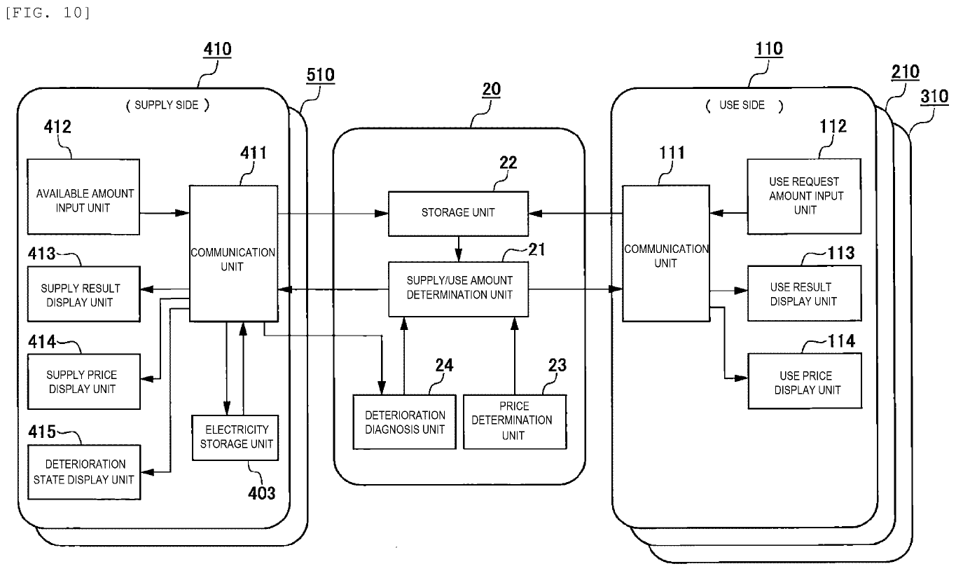

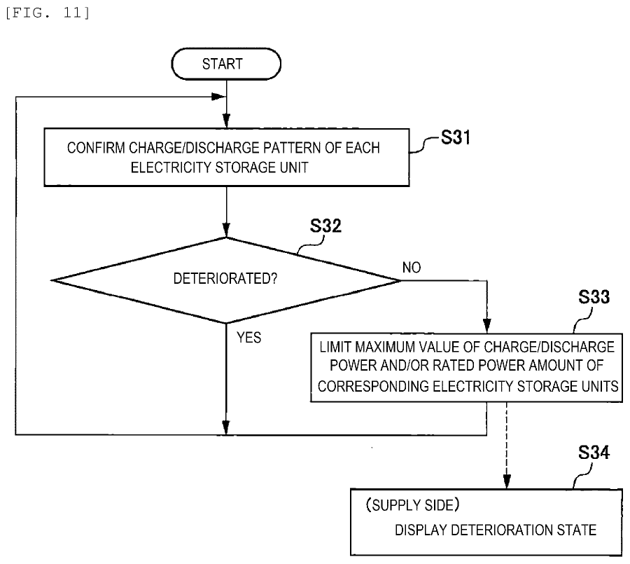

Next, a third embodiment of the invention will be described with reference to FIGS. 10 and 11. In FIG. 10 showing the third embodiment, components same as those in FIGS. 2 and 8 described in the first and second embodiments are denoted by the same reference numerals and a repeated description thereof will be omitted.

In the third embodiment, as shown in FIG. 10, the integrated control device 20 includes the price determination unit 23 and a deterioration diagnosis unit 24 in addition to the supply/use amount determination unit 21 and the storage unit 22. The user side control device 110 includes the use price display unit 114, and the provider side control device 410 includes the supply price display unit 414 and a deterioration state display unit 415.

The price determination in the price determination unit 23 and the price display processing in the use price display unit 114 and the supply price display unit 414 are the same as those described in the second embodiment, and a description thereof will be omitted.

The deterioration diagnosis unit 24 of the integrated control device 20 diagnoses deterioration states of electricity storage elements provided in electricity storage units (for example, the electricity storage unit 403) of respective facilities. For example, the deterioration diagnosis unit 24 collects information such as a voltage, a current, a temperature, and a charge state of the electricity storage unit 403 via the communication unit 411, and diagnoses a deterioration state according to the collected information. The deterioration diagnosis result obtained in the deterioration diagnosis unit 24 is displayed on the deterioration state display unit 415 including the electricity storage unit 403. The integrated control device 20 may display the degradation diagnosis result.

FIG. 11 is a flowchart showing an example of a flow of processing performed by the deterioration diagnosis unit 24.

First, the deterioration diagnosis unit 24 confirms charge/discharge behaviors of the electricity storage units 103, 203, 403, and 502 provided in the respective facilities (step S31). At this time, the deterioration diagnosis unit 24 acquires information necessary for deterioration diagnosis, for example, the voltage, the current, the temperature, and the charge state or the like of the electricity storage unit, from the user side control device 110 or the provider side control device 410. At this time, the deterioration diagnosis unit 24 may specify a charge/discharge pattern suitable for the deterioration diagnosis. In this way, the accuracy of the deterioration diagnosis can be improved.

Then, the deterioration diagnosis unit 24 determines whether the respective electricity storage units 103, 203, 403 and 502 are deteriorated on the basis of the information confirmed in step S31 (step S32). If it is determined that there is no deterioration (YES in step S32), the deterioration diagnosis unit 24 returns the processing to the confirmation processing in step S31.

If it is determined in step S32 that there is a deteriorated electricity storage unit (NO in step S32), the deterioration diagnosis unit 24 limits a maximum value of charge power and discharge power of the corresponding electricity storage unit on the basis of a deterioration state (step S33). Then, the processing returns to the confirmation processing in step S31.

Further, when the limiting processing for the deteriorated electricity storage unit is performed in step S33, the deterioration diagnosis unit 24 of the integrated control device 20 sends the deterioration state information to the deterioration state display unit 415 of the facility including the deteriorated electricity storage unit (for example, the electricity storage unit 403) (step S34). As the display of the deterioration state in the deterioration state display unit 415, for example, it is displayed how much capacity is reduced due to the deterioration. When an available amount is input by the available amount input unit 412 on the facility side, the available amount may be limited on the basis of the diagnosis result of the deterioration diagnosis unit 24.

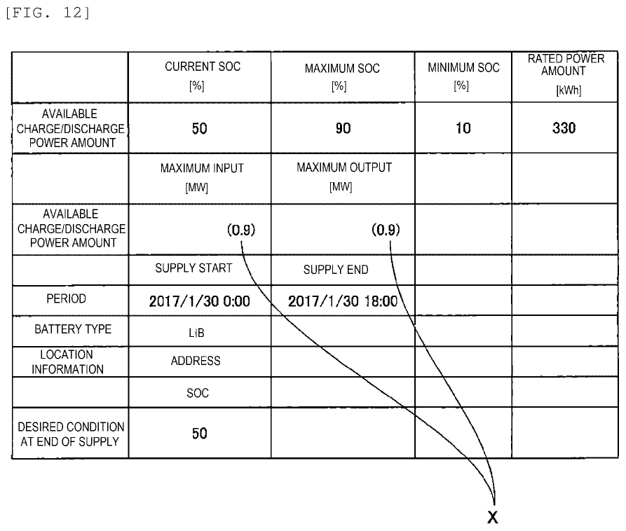

For example, as shown in FIG. 12, a value x limited due to deterioration is displayed in columns of a maximum input and maximum output of the available amount on a screen for inputting the available amount. In the example of FIG. 12, the maximum input [0.9 MW] and the maximum output [0.9 MW] of the available amount are displayed as the value limited due to deterioration, and it is limited in such that the available amount is no more than the limited value. This limitation is performed by the deterioration diagnosis unit 24, and the limitation is transmitted from the integrated control device 20 to the provider side control device 410 and displayed on the deterioration state display unit 415. In the example of FIG. 12, the maximum input and the maximum output of the available amount are 1 MW when there is no limitation due to deterioration (FIG. 6).

By performing the limitation due to the deterioration as described above, it is possible to deal with a case where actual supply capacity decreases due to the deterioration of each electricity storage unit.

When the deterioration diagnosis unit 24 performs the deterioration diagnosis, the price determination unit 23 may change a supply price or a use price of the deteriorated electricity storage unit. For example, the price may be set such that the electricity storage unit which is less deteriorated is preferentially used and the use of the deteriorated electricity storage unit may be controlled.

In the third embodiment, the integrated control device 20 is configured to include both the price determination unit 23 and the deterioration diagnosis unit 24, but the price determination unit 23 may be omitted, and the price may be changed based on the diagnosis result in the deterioration diagnosis unit 24.

### <4. Modification>

The system configuration described in the above embodiments is just an example, and the invention is not limited to the configuration shown in the drawings. For example, the system configuration shown in FIG. 1 is an example, and the number of power supply facilities and user facilities is not limited to the example shown in FIG. 1. The power system 10 may be a power system dedicated to the system of the invention, in addition to a system operated by a power company or a power transmission/distribution company. In this case, in addition to a power system using AC power, a power system using DC power may be used.

Configurations of each power supply facility and each user side facility are not limited to the above-described embodiments. For example, as an electricity storage unit 403 or 502 provided in the power supply facility, an electricity storage unit mounted on a vehicle (automobile), in addition to the electricity storage unit provided in the facility, may be connected. In this case, the facility side control device may specify a time zone in which the vehicle is connected to a facility (such as a building or a house) to the integrated control device 20 to use the this time zone.

The invention is not limited to the above-described embodiments and includes various modifications. For example, the above-described embodiments are detailed for easy understanding but the invention is not necessarily limited to include all the above-described configurations.

A part or all of the above-mentioned configurations, functions, processing units, processing methods, or the like may be achieved by hardware, for example, by being designed as an integrated circuit. The above configurations, functions, or the like may be realized by software in such a way that a processor interprets and executes a program for realizing each function. Information of programs, tables, files or the like for implementing each function can be placed in a recording device such as a memory, a hard disk, and a Solid State Drive (SSD), or a recording medium such as an IC card, an SD card, and a DVD.

Only control lines and information lines that are considered to be necessary for description are illustrated, and not all the control lines and information lines in the product are necessarily illustrated. It may be considered that in practice, almost all of the configurations are mutually connected.

### REFERENCE SIGN LIST

10 . . . power system, 20 . . . integrated control device, 21 . . . supply/use amount determination unit, 22 . . . storage unit, 23 . . . price determination unit, 24 . . . deterioration diagnosis unit, 100, 200, 300 . . . user side facility, 400, 500 . . . power supply facility, 101, 201, 301 . . . power source device, 102, 202, 302 . . . load device, 103, 203, 403, 502 . . . electricity storage unit, 402 . . . photovoltaic power generation device, 110, 210, 310 . . . user side control device, 111 . . . communication unit, 112 . . . use request amount input unit, 113 . . . use result display unit, 114 . . . use price display unit, 410, 510 . . . provider side control device, 411 . . . communication unit, 412 . . . available amount input unit, 413 . . . supply result display unit, 414 . . . supply price display unit, 415 . . . deterioration state display unit, 900 . . . computer device, 901 . . . central processing unit (CPU), 902 . . . ROM, 903 . . . RAM, 904 . . . nonvolatile storage, 905 . . . network interface, 906 . . . input device, 907 . . . display device, 910 . . . bus line

1. A power management system, comprising:
a power supply facility equipped with an electricity storage unit;
a user facility configured to use power stored in the electricity storage unit; and
an integrated control unit configured to control supply of the power stored in the electricity storage unit of the power supply facility on the basis of stored-power use request information from the user facility, wherein
the power supply facility includes a provider side control device configured to specify an available capacity and an available time zone of the electricity storage unit to the integrated control device,
the user facility includes a user side control device configured to specify, to the integrated control device, a use request amount and a use request time zone when the stored power of the electricity storage unit is used, and
the integrated control device is configured to control the use of the electricity storage unit so as to satisfy the use request amount and the use request time zone specified by the user side control device and the available capacity and the available time zone specified by the provider side control device.

2. The power management system according to claim 1, comprising:
a plurality of power supply facilities equipped with the electricity storage units, wherein
the integrated control device is configured to add up available capacities and available time zones specified by the respective provider side control devices, calculate an total available capacity in each time zone, and allocates, within the range of the total capacity calculated for each time zone, the use of the respective electricity storage units in the use request amounts specified by the user side control devices.

3. The power management system according to claim 1, wherein
the provider side control device is configured to specify a charge state at the end of the available time zone of the electricity storage unit, and
the integrated control device is configured to end the use of the electricity storage unit in a state where the electricity storage unit is charged or discharged to the specified charge state.

4. The power management system according to claim 1, wherein
the integrated control device is configured to monitor a charge state and a discharge state of the electricity storage unit and diagnose a deterioration state of the electricity storage unit.

5. The power management system according to claim 4, wherein
the integrated control device is configured to limit an available capacity of the corresponding electricity storage unit according to the diagnosed deterioration state, and sends the limitation of the available capacity of the electricity storage unit to the provider side control device.

6. The power management system according to claim 1, wherein
the integrated control device includes a price determination unit, and
the integrated control device sends the price determined or changed by the price determination unit to the provider side control device and the user side control device.

7. A power management device configured to control an electricity storage unit when a user facility uses power stored in the electricity storage unit provided in a power supply facility, wherein
the power management device is configured to control the use of the electricity storage unit so as to satisfy a use request amount and a use request time zone specified by the user facility when the stored power of the electricity storage unit is used and an available capacity and an available time zone specified by the power supply facility.

8. A power management method for controlling supply of power stored in an electricity storage unit of a power supply facility on the basis of the power supply facility including the electricity storage unit, a user facility configured to use the power stored in the electricity storage unit, and stored-power use request information from the user facility, comprising:
a supply capacity specifying step of specifying an available capacity and an available time zone of the electricity storage unit;
a use capacity specifying step of specifying a use request amount and a use request time zone when the stored power of the electricity storage unit is used; and
an electricity storage unit control step of controlling the use of the power storage unit so as to satisfy the use request amount and the use request time zone specified in the use capacity specifying step and the available capacity and the available time zone specified in the supply capacity specifying step.
